(19) United States
(12) Patent Application Publication
(10) Pub. No.: US 2022/0013969 A1
(43) Pub. Date: Jan. 13, 2022

(54) MULTI-OUTPUT POWER ADAPTER

(71) Applicant: Christopher Zack, Wethersfield, CT (US)

(72) Inventor: Christopher Zack, Wethersfield, CT (US)

(21) Appl. No.: 17/343,275

(22) Filed: Jun. 9, 2021

Related U.S. Application Data
(60) Provisional application No. 63/049,108, filed on Jul. 7, 2020.

(51) Int. Cl. H01R 27/02; H02H 9/04; H02M 7/00

(52) U.S. Cl. CPC H01R 27/02; H01R 13/518; H02M 7/003; H02H 9/04

(57) ABSTRACT

A multi-output power adapter includes a housing that has a first end, a second end, and a body extending between the first end and the second end and defining an interior compartment of the housing. An adapter power cord is integrally connected to the first end of the housing and extends into the interior compartment. The adapter power cord is configured to connect to a power source. A primary power cord is integrally connected to the second end of the housing and extends into the interior compartment. The primary power cord is configured to connect to a primary electronic device for supplying a primary power output to the primary electronic device. One or more power outlet ports are positioned on the body of the housing. The one or more power outlet ports are each configured to receive a removable secondary power cord for supplying a secondary power output to a secondary electronic device. The primary power output and the secondary power output are supplied simultaneously.

### CROSS-REFERENCE TO RELATED APPLICATIONS

The present application is a non-provisional application of, and claims priority benefit to, commonly owned and co-pending U.S. Provisional Patent Application No. 63/049,108 filed on Jul. 7, 2020, the contents of which are incorporated herein by reference in its entirety.

### TECHNICAL FIELD

The present invention is directed to power supply adapters for supplying power to electronic devices, such as portable electronic devices, and the present invention is specifically directed to power supply adapters that supply a dedicated voltage to a primary electronic device and one or more differing voltages to one or more secondary electronic devices.

### BACKGROUND

Electronic devices such as computers, monitors, televisions, projectors, etc. are typically powered by power supply adapters that convert alternating current (“AC”) power to direct current (“DC”) power with circuitry that rectifies the DC power to a voltage required by the electronic device. Powering multiple electronic devices is difficult in locations that have a limited number of AC power outlets.

The traditional solution to this problem is to use a multi-outlet power strip. However, power strips are separate hardware components that are bulky and cumbersome to transport. Additionally, power strips generally require placement near an AC power outlet such that multiple power strips and/or extension cords may be needed to power multiple electronic devices located on a desk or table. Even if a power strip can be placed on a desk, the bulky power strip takes up vital space on the desk.

Thus, there is a need for an improved power adapter to address the problems discussed above.

### SUMMARY

There is disclosed herein a power adapter including a housing. The housing has a first end, a second end, and a body extending between the first end and the second end and defining an interior compartment of the housing. An adapter power cord is integrally connected to the first end of the housing and extends into the interior compartment. The adapter power cord is configured to connect to a power source. A primary power cord is integrally connected to the second end of the housing and extends into the interior compartment. The primary power cord is configured to connect to a primary electronic device for supplying a primary power output to the primary electronic device. One or more power outlet ports are positioned on the body of the housing. The one or more power outlet ports are each configured to receive a removable secondary power cord for supplying a secondary power output to a secondary electronic device. The primary power output and the secondary power output are supplied simultaneously.

In some embodiments, a surge suppression unit is positioned in the interior compartment of the housing and is in electrical communication with the adapter power cord.

In some embodiments, a primary power converter unit is in electrical communication with the surge suppression unit and the primary power cord. The primary power converter unit is configured to convert electrical power received from the power supply into the primary power output supplied to the primary electronic device.

In some embodiments, a secondary power converter unit is in electrical communication with the surge suppression unit and the one or more power outlet ports. The secondary power converter unit is configured to convert electrical power received from the power supply into the secondary power output supplied to the secondary electronic device.

In some embodiments, the one or more power outlet port includes one or more Universal Serial Bus sockets.

In some embodiments, the secondary power output is substantially equal to the electrical power received from the power supply. A pass-through unit is in electrical communication with the surge suppression unit and the one or more power outlet ports for supplying the secondary power output to the secondary electronic device.

In some embodiments, the one or more power outlet port includes one or more alternating current sockets.

There is also disclosed herein a power adapter including a housing and a surge suppression unit positioned inside the housing. An adapter power cord is secured to the housing and is in electrical communication with the surge suppression unit. The adapter power cord is configured to connect to a power source for supplying electrical power to the power adapter. A primary power converter unit is in electrical communication with the surge suppression unit. The primary power converter unit is configured to convert the electrical power into a primary power output. A primary power cord is secured to the housing and connected to the primary power converter unit. The primary power cord is configured to connect to a primary electronic device for supplying the primary power output to the primary electronic device. A plurality of power outlet ports are positioned on the housing. Each of the plurality of power outlet ports is configured to receive a removable secondary power cord for supplying a secondary power output to a secondary electronic device. The primary power output and the secondary power output are supplied simultaneously.

In some embodiments, the plurality of power outlet ports includes one or more direct current sockets.

In some embodiments, a secondary power converter unit is in electrical communication with the surge suppression unit and one or more direct current sockets. The secondary power converter unit is configured to convert the electrical power into the secondary power output.

In some embodiments, the one or more direct current sockets are Universal Serial Bus sockets.

In some embodiments, the plurality of power outlet ports includes at least one alternating current sockets.

In some embodiments, the secondary power output is substantially equal to the electrical power received from the power supply. A pass-through unit is connected to the surge suppression unit and the one or more alternating current sockets.

### BRIEF DESCRIPTION OF THE DRAWINGS

FIG. 1 is a top view of a multi-output power adapter according to an embodiment of the present invention;

FIG. 2 is a schematic view showing the internal circuitry of the power adapter of FIG. 1;

FIG. 3 is a side isometric view of the power adapter of FIG. 1; and

FIG. 4 is a block diagram schematic view of the power adapter of FIG. 3.

### DETAILED DESCRIPTION

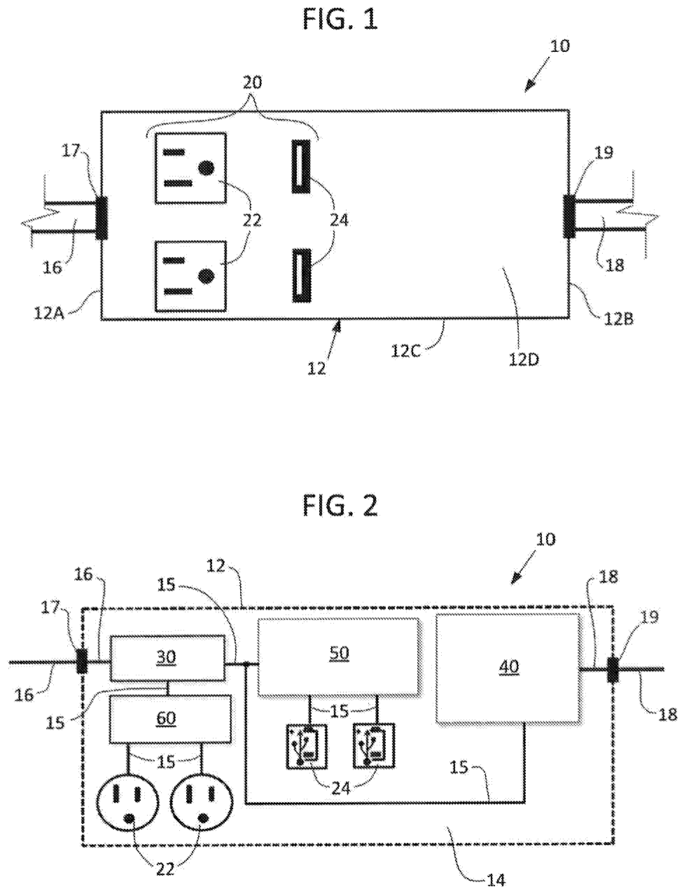

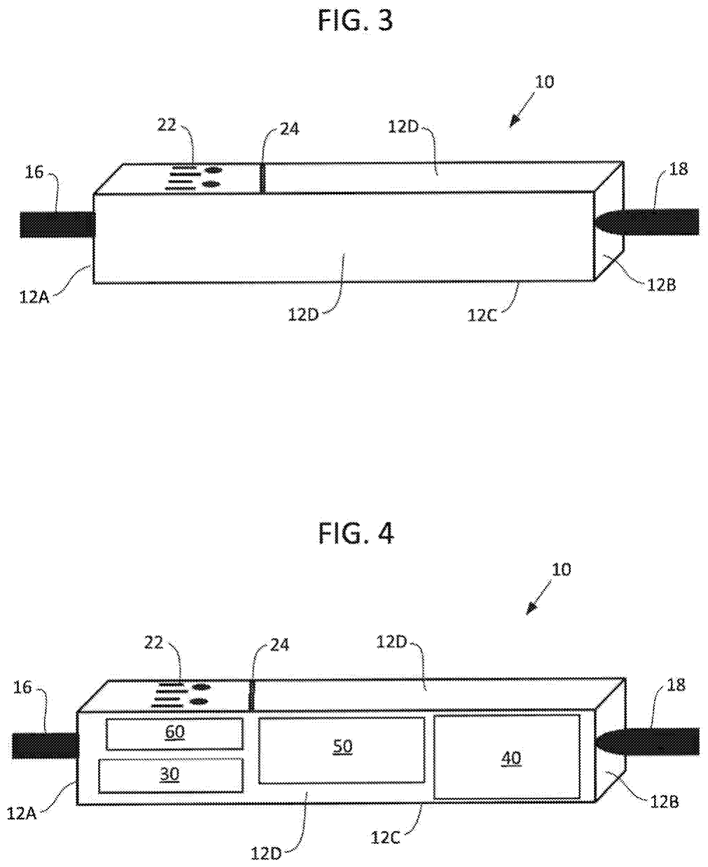

Referring to the drawing figures, a multi-output power adapter according to embodiments of the present invention is designated by reference numeral 10. As shown in FIG. 1, the power adapter 10 includes a housing 12 that has a first end 12A, a second end 12B, and a body 12C extending between the first end 12A and the second end 12B. The body 12C includes a plurality of sidewalls 12D that, with the first end 12A and the second end 12B, define an interior compartment 14, as shown in FIGS. 2-3.

As shown in FIGS. 1 and 2, an adapter power cord 16 is connected to the housing 12 at the first end 12A and extends into the interior compartment 14. The adapter power cord 16 is configured to connect to an alternating current (“AC”) power source, such as a wall outlet in a building, for supplying electric power to the power adapter 10. The adapter power cord 16 is fixedly secured to the first end 12A via a first seal 17 such that the adapter power cord 16 is integrally connected to the housing 12. In some embodiments, the adapter power cord 16 is removably connected to the first end 12A via a plug and socket (not shown) such that the adapter power cord 16 can be removed from the housing 12 for increased convenience when traveling.

As shown in FIGS. 1 and 2, a primary power cord 18 is connected to the housing 12 at the second end 12B and extends into the interior compartment 14. The primary power cord 18 is configured to connect to a primary electronic device, such as a laptop computer, monitor, television, projector, printer, scanner, copier, etc., for supplying direct current (“DC”) power to the primary electronic device. The primary power cord 18 is fixedly secured to the second end 12B via a second seal 19 such that the primary power cord 18 is integrally connected to the housing 12. In some embodiments, the primary power cord 18 is removably connected to the second end 12B via a plug and socket (not shown) such that the primary power cord 18 can be removed from the housing 12 for increased convenience when traveling. The primary power cord 18 is not configured to connect to any of the power outlet ports 20 that are used to supply power to a secondary electronic device, as discussed in detail below.

As shown in FIG. 1, the adapter 10 includes one or more power outlet ports 20 positioned on the body 12C of the housing 12. Each power outlet port 20 is configured to receive a secondary power cord (not shown) for supplying AC or DC power to a secondary electronic device, such as a mobile telephone, tablet, computer, monitor, television, projector, printer, scanner, copier, etc. In the embodiment shown in FIGS. 1, 3, and 4, the power outlet ports 20 are all positioned on one of the plurality of sidewalls 12D of the body 12C of the housing 12. However, the present invention is not limited thereto and contemplates alternative embodiments and arrangements, including but not limited to one or more of the power outlet ports 20 being positioned on one or more different sidewalls 12D.

In the embodiment shown in FIG. 1, the adapter 10 includes two AC sockets 22 and two DC sockets 24. The AC sockets 22 are standard regional AC sockets such as, for example, North American sockets, European sockets, British sockets, Chinese sockets, Japanese sockets, Australian sockets, etc. In some embodiments, the AC sockets 22 are universal sockets. The DC sockets 24 are Universal Serial Bus (“USB”) sockets such as, for example, USB-A sockets, USB-B sockets, Mini-USB sockets, Micro-USB sockets, USB-C, Lighting Cable sockets, etc., and combinations thereof. In some embodiments, the DC sockets 24 are any other known DC sockets, such as DC sockets for receiving coaxial cables, snap and lock connectors, pin and socket connectors, etc. The adapter power cord 16 preferably has a sufficient length (e.g., about 4 feet to about 6 feet) such that the adapter 10 can be positioned in close proximity to (e.g., on a desk, table, counter, etc.) the primary and secondary electronic devices being powered by the adapter 10. Although the embodiment shown and discussed regarding the drawing figures has two AC sockets 22 and two DC sockets 24, the present invention is not limited thereto and contemplates alternative embodiments and arrangements having any number of power outlet ports 20, including but not limited to the adapter 10 having one AC socket 22 and two DC sockets 24, one AC socket 22 and three DC sockets 24, two AC sockets 22 and one DC socket 24, three AC sockets 22 and one DC socket 24, three AC sockets 22 and three DC sockets 24, four AC sockets 22 and four DC sockets 24, etc.

As shown in FIG. 2, the adapter 10 includes a surge suppression unit 30 in the interior compartment 14 of the housing 12. The surge suppression unit 30 is positioned adjacent to the first end 12A of the housing 12 and is in electrical communication with the adapter power cord 16, as shown in FIGS. 2 and 4. The surge suppression unit 30 includes any known components and circuitry used for protecting the circuitry of the primary and secondary electronic devices that are being powered by the adapter 10. For example, in some embodiments, the surge suppression unit 30 includes a surge suppressor having circuitry configured to clamp the voltage running through the adapter 10 when the voltage exceeds a predetermined limit. In other embodiments, the surge suppression unit 30 includes a surge protector having circuitry and fuses or breakers that trip when the voltage running through the adapter 10 exceeds a predetermined limit.

As shown in FIG. 2, the adapter 10 includes a primary power converter unit 40 in the interior compartment 14 of the housing 12. The primary power converter unit 40 is positioned adjacent to the second end 12B of the housing 12 and is in electrical communication with the primary power cord 18, as shown in FIGS. 2 and 4. The primary converter 40 is also in electrical communication with the surge suppression unit 30 and is configured to receive the AC power delivered to the adapter 10 by the power source and convert the AC power into a primary power output supplied to the primary electronic device. In some embodiments, the primary power output is DC power having the specific voltage required for powering/charging the primary electronic device.

As shown in FIG. 2, the adapter 10 includes a secondary power converter unit 50 in the interior compartment 14 of the housing 12. The secondary power converter unit 50 is in electrical communication with the surge suppression unit 30 and the DC sockets 24. As shown in FIG. 4, the secondary power converter unit 50 is positioned adjacent to the DC sockets 24. The secondary power converter unit 50 is configured to receive the AC power delivered to the adapter 10 by the power source and convert the AC power into a secondary power output supplied to the secondary electronic devices. In some embodiments, the secondary power output is DC power having a voltage that corresponds to the respective DC socket 24 that is powering/charging the secondary electronic device. In some embodiments, the adapter 10 includes a plurality of different types of DC sockets 24 (e.g., USB-A, USB-B, USB-C, etc.) and the secondary power converter unit 50 includes a plurality of power converters each configured to convert the AC power into DC power having the corresponding voltage for a respective DC socket 24.

As shown in FIG. 2, the adapter 10 includes a pass-through unit 60 in the interior compartment 14 of the housing 12. The pass-through unit 60 is in electrical communication with the surge suppression unit 30 and the AC sockets 22. As shown in FIG. 4, the pass-through unit 60 is positioned adjacent to the AC sockets 22. The pass-through unit 60 includes circuitry configured to deliver a secondary power output to the AC sockets 22 for powering/charging the secondary electronic devices. In some embodiments, the pass-through unit 60 includes circuitry configured to deliver the AC power received from the power source to the AC sockets 22 for powering/charging the secondary electronic devices that require AC power. Thus, in some embodiments, the secondary power output is AC power having a current and voltage that are equal or substantially equal to the current and voltage of the AC power supplied by the power source such that the AC sockets 22 are configured to supply power to the secondary electronic devices as if the secondary electronic devices were connected directly to the power source. As used herein regarding the AC power passed through to the AC sockets 22, the term “substantially equal” takes into account the negligible voltage and/or current drop that may occur when one or more secondary electronic devices are connected to the AC sockets 22. Thus, while in some embodiments the AC power supplied to the AC sockets 22 is not exactly equal to the AC power supplied by the power source, the AC power supplied to the AC sockets 22 is substantially, or effectively, equal to the AC power supplied by the power source.

As shown in FIG. 2, the AC sockets 22, the DC sockets 24, the surge suppression unit 30, the primary power converter unit 40, the secondary power converter unit 50, and the pass-through unit 60 are in electrical communication with each other via electrical wiring 15. The surge suppression unit 30 is in electrical communication with the primary power converter unit 40, the secondary power converter unit 50, and the pass-through unit 60 via respective electrical wiring 15. The AC sockets 22 are each in electrical communication with the pass-through unit 60 via respective electrical wiring 15. The DC sockets 24 are each in electrical communication with the secondary power converter unit 50 via respective electrical wiring 15. Preferably, the AC sockets 22, the DC sockets 24, the surge suppression unit 30, the primary power converter unit 40, the secondary power converter unit 50, and the pass-through unit 60 are in electrical communication with each other via electrical wiring 15 arranged in parallel such that electrical failure of one or more components does not result in electrical failure of the entire power adapter 10.

In some embodiments, the adapter 10 is configured to simultaneously supply the primary power output to the primary electronic device and supply the secondary power outputs to the secondary electronic devices. Preferably, the simultaneous supply of the secondary power outputs does not interfere with the supply of the primary power output. Thus, in some embodiments, the surge suppression unit 30 prioritizes clamping or cutting off the power supplied to the secondary electronic devices before clamping or cutting off the power supplied to the primary electronic device.

While the present disclosure has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A power adapter comprising:
a housing having a first end, a second end, and a body portion extending between the first end and the second end and defining an interior compartment of the housing;
an adapter power cord integrally connected to the first end of the housing and extending into the interior compartment, the adapter power cord being configured to connect to a power source;
a primary power cord integrally connected to the second end of the housing and extending into the interior compartment, the primary power cord is configured to connect to a primary electronic device for supplying a primary power output to the primary electronic device; and
at least one power outlet port positioned on the body of the housing, each of the at least one power outlet port being configured to receive a removable secondary power cord configured to supply a secondary power output to a secondary electronic device;
wherein the primary power output and the secondary power output are supplied simultaneously.

2. The power adapter of claim 1, further comprising a surge suppression unit positioned in the interior compartment of the housing and in electrical communication with the adapter power cord.

3. The power adapter of claim 2, further comprising a primary power converter unit in electrical communication with the surge suppression unit and the primary power cord, the primary power converter unit is configured to convert electrical power received from the power supply into the primary power output supplied to the primary electronic device.

4. The power adapter of claim 2, further comprising a secondary power converter unit in electrical communication with the surge suppression unit and the at least one power outlet port, the secondary power converter unit is configured to convert electrical power received from the power supply into the secondary power output supplied to the secondary electronic device.

5. The power adapter of claim 4, wherein the at least one power outlet port comprises at least one Universal Serial Bus socket.

6. The power adapter of claim 2, wherein the secondary power output is substantially equal to the electrical power received from the power supply, and wherein the housing further comprises a pass-through unit in electrical communication with the surge suppression unit and the at least one power outlet port for supplying the secondary power output to the secondary electronic device.

7. The power adapter of claim 6, wherein the at least one power outlet port comprises at least one alternating current socket.

8. A power adapter comprising:
a housing;
a surge suppression unit positioned inside the housing;
an adapter power cord secured to the housing and in electrical communication with the surge suppression unit, the adapter power cord is configured to connect to a power source for supplying electrical power to the power adapter;
a primary power converter unit in electrical communication with the surge suppression unit, the primary power converter unit is configured to convert the electrical power into a primary power output;
a primary power cord secured to the housing and connected to the primary power converter unit, the primary power cord is configured to connect to a primary electronic device for supplying the primary power output to the primary electronic device;
a plurality of power outlet ports positioned on the housing, each of the plurality of power outlet ports is configured to receive a removable secondary power cord configured to supply a secondary power output to a secondary electronic device;
wherein the primary power output and the secondary power output are supplied simultaneously.

9. The power adapter of claim 8, wherein the plurality of power outlet ports comprises at least one direct current socket.

10. The power adapter of claim 9, further comprising a secondary power converter unit in electrical communication with the surge suppression unit and the at least one direct current socket, the secondary power converter unit is configured to convert the electrical power into the secondary power output.

11. The power adapter of claim 9, wherein the at least one direct current socket is a Universal Serial Bus socket.

12. The power adapter of claim 8, wherein the plurality of power outlet ports comprises at least one alternating current socket.

13. The power adapter of claim 12, wherein the secondary power output is substantially equal to the electrical power received from the power supply, and wherein the housing further comprises a pass-through unit connected to the surge suppression unit and the at least one alternating current socket.
